(19) United States
(12) Patent Application Publication
(10) Pub. No.: US 2008/0026179 A1
(43) Pub. Date: Jan. 31, 2008

(54) THERMAL SPREADER FOR ELECTRONIC COMPONENT

(75) Inventors: SAM SHIAO, CERRITOS, CA (US); DENNIS M. MORITA, RANCHO PALOS VERDES, CA (US); STEVEN M. SHIMOTANI, RANCHO PALOS VERDES, CA (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., MORRISTOWN, NJ (US)

(21) Appl. No.: 11/461,115

(22) Filed: Jul. 31, 2006

(51) Int. Cl. B32B 3/06; B32B 3/10

(52) U.S. Cl. 428/102; 428/131

(57) ABSTRACT

A thermal spreader for electronic components may include a plurality of carbon fiber laminate layers having a layer of stitched fibers formed thereupon. The thermal spreader may be attached to the electronic components as a thermal pad, or the thermal spreader may be extended to include attachment to a cold plate. The use of a stitched fiber layer on top of a carbon fiber laminate results in increased thermal cooling efficiency due to the increase in surface area and convectional cooling area.

### BACKGROUND OF THE INVENTION

The present invention generally relates to a thermal spreader for electronic components and, more specifically, to a thermal spreader having stitched fibers on the top thereof for removing heat from electronic components.

It is generally recognized that keeping electronic components cooler when operating will increase the reliability and/or life of the component. The effective removal of waste heat within a limited controller space often poses a challenge to designers.

Referring to FIG. 1, there is shown a conventional method for removing heat from high power electronic components 10. The components 10 may be mechanically secured and/or adhered to a cold plate 12 so that heat can be conducted away through the bottom of the component 10.

Referring to FIG. 2, there is shown a conventional method for further removing heat from high power electronic components 20. Not only may the components 20 be bolted and/or glued to a cold plate 22 so that heat can be conducted away through the bottom of the component 20, but also, an aluminum cover 24 may be used to conduct heat away from the component 20 to the cold plate 22. Good thermal contact between the aluminum cover 24 and the component 20 is required for efficient conduction of heat via this method.

U.S. Pat. No. 5,975,201, issued to Roberts et al., describes polymer matrix components having an increased through-thickness thermal conductivity. The '201 patent uses an interlamination of a high thermal conductivity pitch fiber/epoxy and a low thermal conductivity carbon fabric epoxy within a sandwich of copper foil outer plies. A plurality of vias may be formed through the final laminated product. The walls of these vias may be lined with copper to increase the thermal conductivity through the layers of the lamination.

U.S. Pat. No. 5,852,548, issued to Koon et al., describes attaching thermally conductive fibers to at least a portion of an exterior surface of a circuit board and/or electronic component thereof. The fibers extend out from the exterior surfaces in a generally perpendicular direction and are used to conduct heat from the circuit board and/or electronic component to a surrounding gas. The fibers are attached to the surface via an electrostatic fiber flocking method and are subsequently glued thereon. This method requires a substantial height of the attached fibers to provide adequate heat transfer from the circuit board and/or electronic component to the gas surrounding it.

As can be seen, there is a need for an improved apparatus and methods for the thermal spread of heat from electronic components within a limited controller space.

### SUMMARY OF THE INVENTION

In one aspect of the present invention, a thermal spreader comprises at least one carbon laminate layer; and a stitched fiber layer on top of the carbon laminate layer.

In another aspect of the present invention, an apparatus for the cooling of electronic components comprises a carbon laminate layer molded to the contours of the electronic components; and a stitched fiber layer stitched into the carbon laminate layer.

In yet another aspect of the present invention, a thermal pad for cooling electronic components comprises at least one carbon laminate layer; and a stitched fiber layer on top of the carbon laminate layer.

These and other features, aspects and advantages of the present invention will become better understood with reference to the following drawings, description and claims.

### BRIEF DESCRIPTION OF THE DRAWINGS

FIG. 1 is a perspective view of prior art electronic components cooled by a cold plate;

FIG. 2 is a perspective view of prior art electronic components cooled by a cold plate and aluminum cover;

FIG. 3 is a perspective view of electronic components cooled by a carbon fiber laminate and stitched fibers according to one embodiment of the present invention;

FIG. 4 is a perspective view of the electronic components of FIG. 3 removed from its housing to show methods of attaching the carbon fiber laminate according to the present invention;

FIG. 5A is a close up view of the carbon fiber laminate and the stitched fibers according to the present invention;

FIG. 5B is a close up view of the carbon fiber laminate and the stitched fibers according to another embodiment of the present invention and

FIG. 6 is a perspective view of electronic components cooled using a thermal pad having a carbon fiber laminate and stitched fibers according to another embodiment of the present invention.

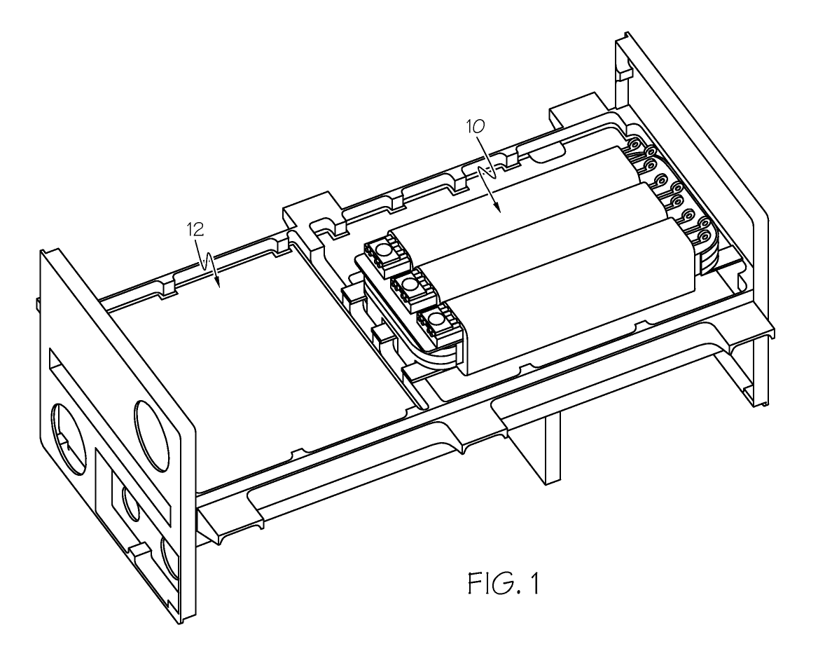

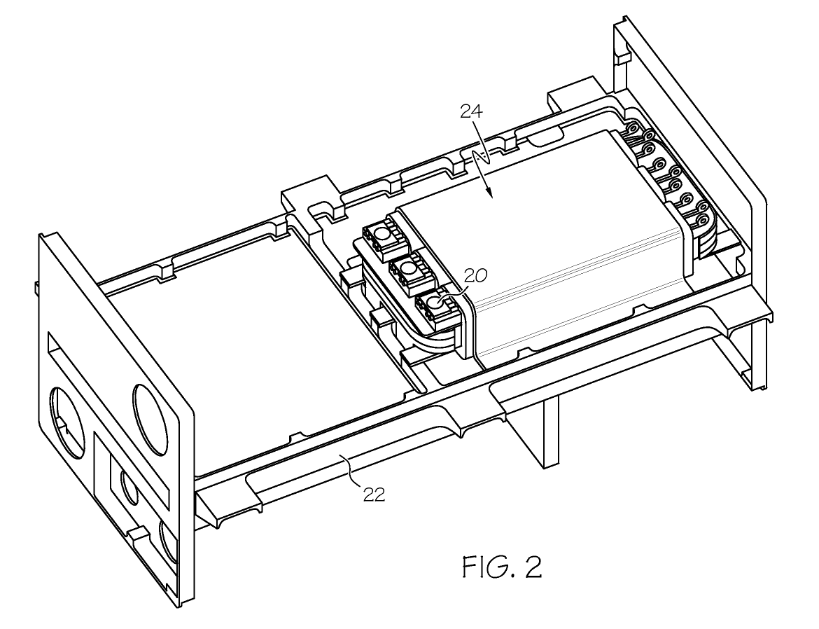

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Briefly, the present invention provides a carbon fiber laminate having stitched therein a plurality of stitched carbon fibers. The carbon fiber laminate and stitched fibers may comprise a thermal spreader for electronic components. The stitched fibers may have various loop heights, resulting in a thermal spreader that may provide additional heat dissipating surface area, thereby increasing the thermal efficiency of the thermal spreader. The thermal spreader of the present invention may be useful in applications where there is a need for the dissipation of heat from high power electronic components. Such industries may include the aerospace industry, avionics and automotive industries.

Conventional thermal spreaders may use an aluminum sheet and/or a carbon fiber sheet as heat transfer devices. These conventional thermal spreaders, however, often are inefficient or require additional space or a complex manufacture method. The thermal spreader of the present invention may provide excellent thermal efficiency by providing stitched fibers on an exterior surface of a carbon laminate thermal spreader. The resulting increased surface area due to the carbon fibers may increase convectional cooling of the thermal spreader, thereby resulting in greater efficiency.

Carbon fiber may have a nominal thermal conduction of 1100 W/m K° and a carbon fiber with polymer (a carbon fiber laminate) may have a nominal in-plane thermal conduction of 300 W/m K°. This compares favorably with conventional aluminum thermal spreaders, as aluminum has a thermal conduction of about 150 W/m K°. Therefore, the thermal conduction of carbon fiber laminate layers will remove heat faster than a comparable thermal spreader made of aluminum.

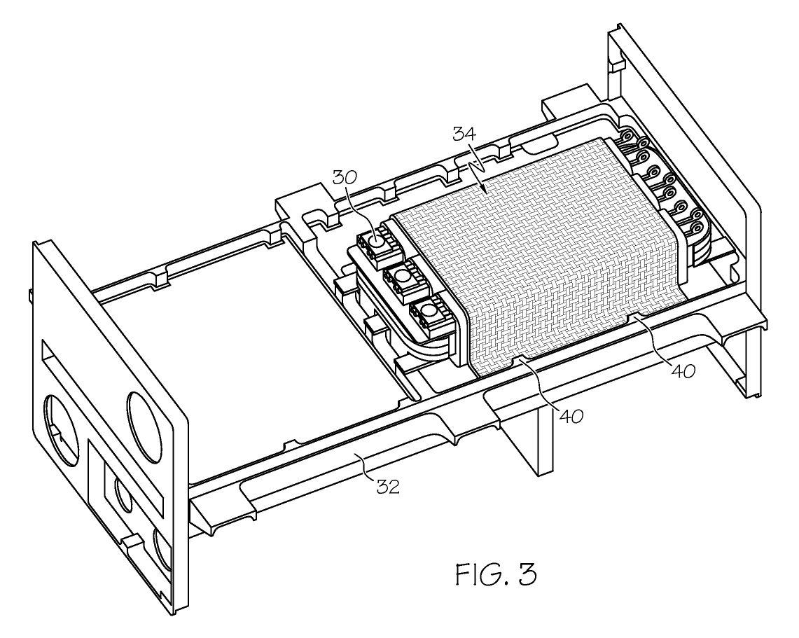

Referring to FIG. 3, there is shown a perspective view of electronic components 30 conductively cooled by a carbon fiber composite 34 according to one embodiment of the present invention. The electronic components 30 may be attached to a cold plate 32. An attachment section 40 may be used to attach the carbon fiber composite 34 to the cold plate 32.

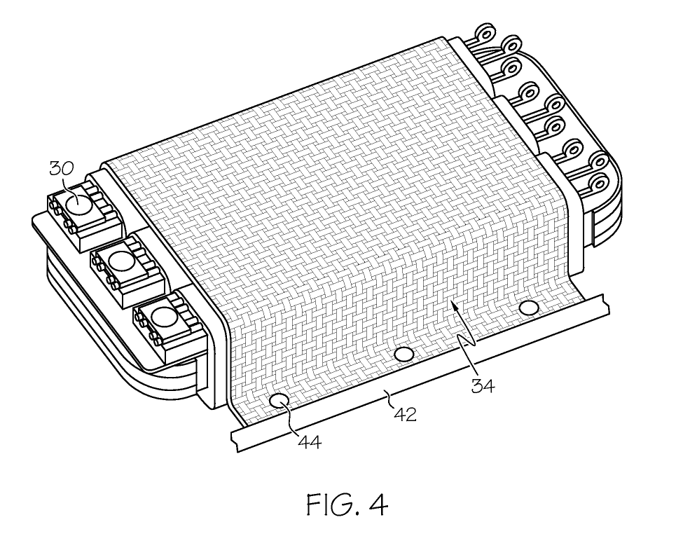

Referring now to FIG. 4, there is shown a perspective view of the electronic components 30 of FIG. 3, with the cold place 32 removed, in order to provide a better view of the attachment section 40. The carbon fiber composite 34 may be attached to cold plate 32 by an attachment strip 42. Alternatively, or in addition to the attachment strip 42, a plurality of holes 44 may be provided through the carbon fiber composite 34 to allow for mechanically attaching the carbon fiber composite 34 to the cold plate 32. In this embodiment, the holes 44 may be plated with a thermally-conductive material, for example, copper, to increase thermal conductivity through the holes 44. While the above refers to examples for attaching the carbon fiber composite 34 to the cold plate 32, any known method may be used to make this attachment.

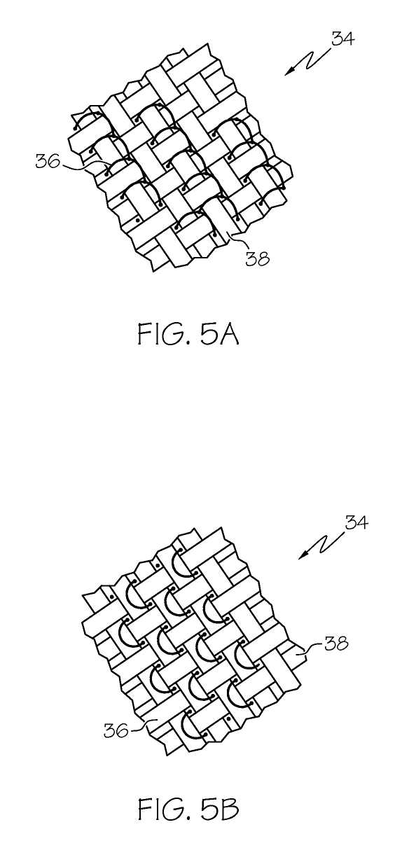

Referring to FIGS. 5A and 5B, there is shown a close up views of the carbon fiber composite 34 of FIG. 3, showing two patterns for stitching the carbon fiber composite 34. Carbon fiber composite 34 may comprise a plurality of carbon fiber laminate layers 38. The carbon fiber laminate layers 38 may comprise carbon fibers in a polymer matrix. The polymer may be chosen from any of the polymers known in the art. As examples, epoxies and polyimides may be useful polymers to make the carbon fiber laminate layers 38 of the present invention. The carbon fiber laminate layers 38 may be made by any conventional means. As examples, the carbon fiber laminate layers 38 may be made from any one of the processes disclosed in U.S. Pat. Nos. 4,356,227, 4,543,145 and 4,892,780, each herein incorporated by reference. The carbon fiber laminate layers 38 may have a generally planar geometry and may be shaped to the contour of the electronic components. As an example, from about 2 to about 6 carbon fiber laminate layers 38 may be stacked together to form the carbon fiber composite 34. The thickness of the carbon fiber composite 34 may vary depending on the particular application and typically may be from about 15 to about 40 mils.

The stitched fibers 36 may comprise carbon fibers woven into at least one carbon fiber laminate layer 38 and having loops extending above/below the carbon fiber laminate layer 38. The stitched fibers 36 may have loop heights varying from about two times to about 5 times the thickness of the carbon fiber composite 34. Typically, the loop height of the stitched fibers 36 may be from about 3 times to about 4 times the thickness of the carbon fiber composite 34. For typical applications, the loop height may range from about 50 to about 100 mils. The stitched fibers 36 may provide an increased surface area for convection cooling of the carbon fiber composite 34. The stitched fibers 36 may be attached to the carbon fiber laminate layers 38 by any conventional means. For example, the stitched fibers 36 may be attached to the carbon fiber laminate layers 38 by a variation of methods disclosed in U.S. Pat. No. 6,051,089, herein incorporated by reference. The stitched fibers 36 may be any conventional carbon fiber, including vapor grown carbon fibers and pitch based carbon fibers. While FIGS. 5A and 5B shows different ways to stitch fibers to the carbon fiber laminate, the invention is not limited to such methods, and any conventional stitching methods and patterns may be used in the present invention.

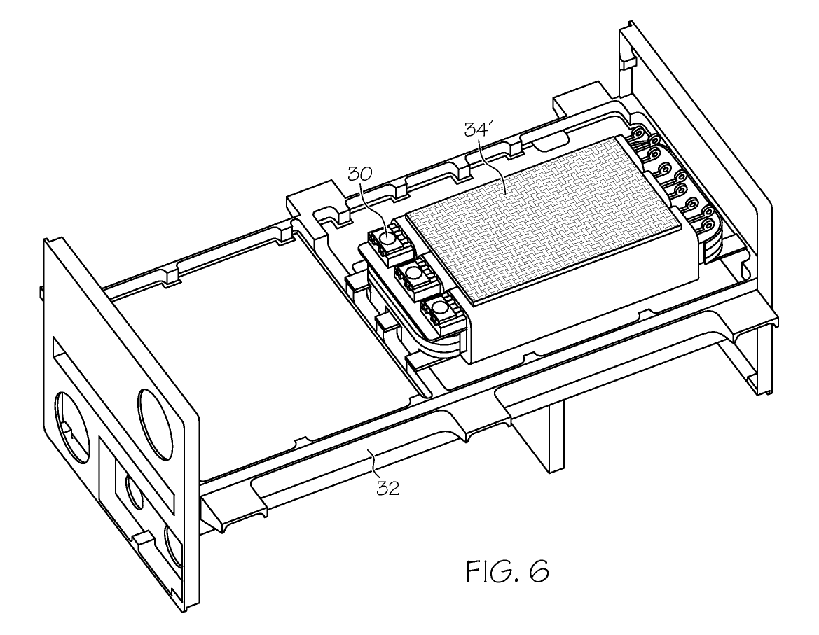

Referring now to FIG. 6, there is shown a perspective view of electronic components 30 cooled using a thermal pad 34′ having a carbon fiber laminate and stitched fibers (not shown) according to another embodiment of the present invention. In this embodiment of the present invention, the carbon fiber composite 34 may be used as a thermal pad 34′. The thermal pad 34′ may be glued to the surface of the electronic components 30 by any conventional means. The thermal pad 34′, having the stitched fibers as previously described, may result in improved cooling of the electronic components 30 due to the increased convectional cooling of the thermal pad 34′.

It should be understood, of course, that the foregoing relates to preferred embodiments of the invention and that modifications may be made without departing from the spirit and scope of the invention as set forth in the following claims.

We claim:

1. A thermal spreader comprising:
at least one carbon laminate layer; and
a stitched fiber layer secured to the carbon laminate layer.

2. The thermal spreader according to claim 1, wherein the at least one carbon laminate layer comprises a carbon fiber and a polymer.

3. The thermal spreader according to claim 1, wherein the at least one carbon laminate layer comprises from about 2 to about 5 carbon laminate layers.

4. The thermal spreader according to claim 1, wherein the stitched fiber layer comprises carbon fibers stitched into at least one carbon laminate layer.

5. The thermal spreader according to claim 1, wherein the loop height of the stitched fiber layer is from about 2 to about 5 times the thickness of the at least one carbon fiber laminate layer.

6. The thermal spreader according to claim 1, further comprising an attachment strip for attaching the thermal spreader to a cold plate.

7. The thermal spreader according to claim 1, further comprising a plurality of holes at an attachment section of the thermal spreader.

8. The thermal spreader according to claim 7, wherein the holes are plated with a metal.

9. The thermal spreader according to claim 8, wherein the holes are copper plated.

10. There thermal spreader according to claim 7, wherein the holes are adapted to receive mechanical fasteners for attaching the thermal spreader to a cold plate.

11. An apparatus for the cooling of electronic components, the apparatus comprising:
a carbon laminate layer molded to the contours of the electronic components; and
a stitched fiber layer stitched into the carbon laminate layer.

12. The apparatus according to claim 11, wherein the carbon laminate layer comprises from about 2 to about 5 carbon laminate layers.

13. The apparatus according to claim 11, wherein the loop height of the stitched fiber layer is from about 2 to about 5 times the thickness of the carbon laminate layer.

14. The apparatus according to claim 11, further comprising:
an attachment strip for attaching the apparatus to a cold plate, and
wherein the electronic components are attached to the cold plate.

15. The apparatus according to claim 11, further comprising a plurality of holes at an attachment section of the apparatus, the holes being plated with a metal.

16. A thermal pad for cooling electronic components, the thermal pad comprising:
at least one carbon laminate layer; and
a stitched fiber layer secured to the top of the carbon laminate layer.

17. The thermal pad according to claim 16, wherein the at least one carbon laminate layer comprises from about 2 to about 5 carbon laminate layers.

18. The thermal pad according to claim 16, wherein the loop height of the stitched fiber layer is from about 2 to about 5 times the height of the thickness of the at least one carbon laminate layer.

19. The thermal pad according to claim 16, wherein the thermal pad has a generally planar shape, molded to the contours of the electronic components.

20. The thermal pad according to claim 16, wherein the stitched fiber layer comprises carbon fibers stitched into at least one of the at least one carbon laminate layer.
